(19) United States
(12) Patent Application Publication
(10) Pub. No.: US 2013/0227259 A1
(43) Pub. Date: Aug. 29, 2013

(54) CLIENT TERMINAL, OPERATING SYSTEM PROVIDING APPARATUS, AND METHODS FOR SUPPORTING MULTIPLE OPERATING SYSTEMS

(71) Applicant: Pantech Co., Ltd., (US)

(72) Inventor: Sung-Ho KIM, Seoul (KR)

(73) Assignee: PANTECH CO., LTD., Seoul (KR)

(21) Appl. No.: 13/662,892

(22) Filed: Oct. 29, 2012

(30) Foreign Application Priority Data
Feb. 28, 2012 (KR) 10-2012-0020563

(51) Int. Cl. G06F 15/177

(52) U.S. Cl. 713/1; 707/E17.005

(57) ABSTRACT

A client terminal to support multiple operating systems (OSes) runs a first OS and includes a memory having a data area and an OS area, and a processor configured to back up a file stored in the data area to an OS providing apparatus, to format the OS area, to install a second OS received from the OS providing apparatus, and to restore the backed-up file to the data area. Upon rebooting, the client terminal runs the second OS and reuses the restored file if the file is executable under both the first OS and the second OS. The OS providing apparatus includes a data receiving unit, a memory to store the second OS, and a data transmitting unit to transmit the backed-up file and the second OS to the client terminal.

### CROSS-REFERENCE TO RELATED APPLICATION

This application claims priority from and the benefit under 35 U.S.C. §119(a) of Korean Patent Application No. 10-2012-0020563, filed on Feb. 28, 2012, which is incorporated herein by reference for all purposes as if fully set forth herein.

### BACKGROUND

1. Field

The following description relates to a client terminal, an operating system (OS) providing apparatus, and methods for supporting multiple operating systems (OSes).

2. Discussion of the Background

An operating system (OS) is one aspect of a device. Specifically, to choose a portable multifunctional device such as a smartphone or a smart pad, which is commonly referred to as a tablet or small computer, an OS of the device is one of the factors that may be considered by a user, along with the design and functionality of the device.

A device may support multiple OSes. A device equipped with multiple OSes may have physically different areas, such as boot management areas, for the respective OSes. In addition, files including data may be dependent on an OS, and each OS commonly has a different system configuration and executes a program in a different way. Thus, each OS can execute only files or applications that are configured for that particular OS. Thus, when one OS is running, files or applications dependent on another OS cannot be used.

To implement multiple OSes in one device, a memory of the device is required to store each OS and resources for operating the each OS. A system with a regular processor and hardware, for example, a personal computer, does not need many resources to run an OS, whereas a system with a variety of hardware configurations, for example, a portable terminal, requires a greater amount of resources. Specifically, a portable multifunctional device that performs a diversity of functions has more restricted resources available for running the multiple OSes.

### SUMMARY

The following description relates to a client terminal that supports multiple operating systems using resources of an operating system providing apparatus, the operating system providing apparatus, and methods for managing multiple operating systems by the client terminal and the operating system providing apparatus.

Additional features of the invention will be set forth in the description which follows, and in part will be apparent from the description, or may be learned by practice of the invention.

Exemplary embodiments of the present invention provide a terminal configured to run a first OS, including a memory comprising a data area and an OS area, and a processor configured to back up a file stored in the data area to an OS providing apparatus, to format the OS area, to install a second OS received from the OS providing apparatus, and to restore the file to the data area.

Exemplary embodiments of the present invention provide an OS providing apparatus, including a data receiving unit to receive data via a communication network, a memory to store a first OS, and a data transmitting unit to transmit data via the communication network, and to transmit the first OS to a terminal running a second OS.

Exemplary embodiments of the present invention provide a method for managing multiple OSes, including running a first OS, collecting information about a second OS from an OS providing apparatus, backing up a first file stored in a data area of a memory to the OS providing apparatus, formatting an OS area of the memory, receiving the second OS from the OS providing apparatus and installing the second OS to the OS area, restoring the first file to the data area, and running the second OS.

Exemplary embodiments of the present invention provide a method for managing multiple OSes at an OS providing apparatus, including receiving a request from a terminal running a first OS, transmitting information about a second OS to the terminal in response to the request, receiving a first file from the terminal, storing the first file in a memory, transmitting the second OS to the terminal, and transmitting the first file to the terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a client terminal and an operating system providing apparatus according to an exemplary embodiment of the present invention.

FIG. 2 is a diagram illustrating a client terminal according to an exemplary embodiment of the present invention.

FIG. 3 is a diagram illustrating a configuration of a data area of a client terminal according to an exemplary embodiment of the present invention.

FIG. 4 is a diagram illustrating a configuration of a processor of a client terminal according to an exemplary embodiment of the present invention.

FIG. 5 is a diagram illustrating a configuration of a processor of a client terminal according to an exemplary embodiment of the present invention.

FIG. 6 is a diagram illustrating a configuration of a processor of a client terminal according to an exemplary embodiment of the present invention.

FIG. 7 is a flowchart illustrating a method for supporting multiple OSes according to an exemplary embodiment of the present invention.

FIG. 8 is a diagram illustrating a display of a client terminal on which a second OS installation event is displayed according to an exemplary embodiment of the present invention.

FIG. 9 is a diagram illustrating a display of a client terminal according to an exemplary embodiment of the present invention.

FIG. 10 is a flowchart illustrating a method for performing a file searching operation and a file parsing operation according to an exemplary embodiment of the present invention.

FIG. 11 is a diagram illustrating a configuration of software and hardware for a client terminal according to an exemplary embodiment of the present invention.

FIG. 12 is a flowchart illustrating a method for performing a communication process between a client terminal and an OS providing apparatus according to an exemplary embodiment of the present invention.

FIG. 13A, FIG. 13B, and FIG. 13C are diagrams illustrating a process of a client terminal installing a second OS downloaded from an OS providing apparatus according to an exemplary embodiment of the present invention.

FIG. 14 is a diagram illustrating a method of a client terminal backing up a file in an OS providing apparatus according to an exemplary embodiment of the present invention.

FIG. 15 is a diagram illustrating a method of a client terminal fetching a file backed up in an OS providing apparatus and restoring the file in the client terminal according to an exemplary embodiment of the present invention.

FIG. 16 is a diagram illustrating a storage area of an OS providing apparatus according to an exemplary embodiment of the present invention.

FIG. 17 is a diagram illustrating a memory in a client terminal according to an exemplary embodiment of the present invention.

FIG. 18 is a flowchart illustrating a method for supporting multiple OSes according to an exemplary embodiment of the present invention.

### DETAILED DESCRIPTION OF THE ILLUSTRATED EMBODIMENTS

The present disclosure will now be described more fully hereinafter with reference to the accompanying drawings, in which exemplary embodiments are shown. The invention may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. The terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art. While the present disclosure has been described with respect to the exemplary embodiments, it will be apparent to those skilled in the art that various changes and modifications may be made without departing from the spirit and scope of the disclosure as defined in the following claims and their equivalents. Throughout the drawings and the detailed description, unless otherwise described, the same reference numerals are understood to refer to the same elements, features, and structures. The shape, size and regions, and the like, of the drawing may be exaggerated for clarity.

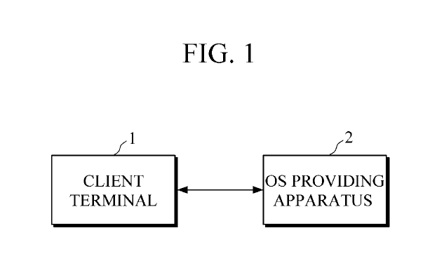

FIG. 1 is a diagram illustrating a client terminal and an operating system providing apparatus according to an exemplary embodiment of the present invention.

Referring to FIG. 1, the operating system providing apparatus (hereinafter, referred to as an “OS providing apparatus”) 2 indicates any type of electronic devices that can provide an OS to the client terminal 1. For example, the OS providing apparatus 2 may be a desk top computer or a notebook computer. In addition, the OS providing apparatus 2 may be a server connected to a network, such as a cloud server.

Hereinafter, the OS providing apparatus 2 will be described as a cloud server that serves a cloud computing service to the client terminal 1. The OS providing apparatus 2 provides computing resources to the client terminal 1 in response to a request from the client terminal 1, which may be transmitted over the Internet. Here, the computing refers to a set of process performed by a device or processor for storing data, processing data, using a network, and the like. The cloud computing indicates an Internet-based computing technology. In a computer network diagram, the Internet is depicted as cloud, which implies a hidden complicated infrastructure. The cloud computing is a type of computing in which information technology-(IT-)related functions are provided in the form of service. The user can be provided with requested computing resources over the Internet, at any time, anywhere. The computing resources are generally managed by individual resource providers, such as a large-capacity data center, and examples of the computing resources may be hardware resources, such as CPU capacity, memory, and storage, and development platform, application programs, and the like. A service that is provided by a resource provider for a user to use the computing capacity in the client terminal 1 may be referred to as a cloud computing service.

The client terminal 1 initially operates on a predetermined OS. The client terminal 1 may be a user terminal that can receive an additional OS from the OS providing apparatus 2. The client terminal 1 may be a terminal device that can communicate with the OS providing apparatus 2, and may be, for example, a mobile phone, a personal digital assistant (PDA), a portable multimedia player (PMP), an MP3 player, a digital camera, a tablet, an e-book reader, and other types of devices. The client terminal 1 may be a portable terminal that possesses less computing capacity than a personal computer. Particularly, the client terminal 1 may be a portable multifunctional device, such as a smart phone or a smart pad or tablet.

In the example, the client terminal 1 stores a first operating system (hereinafter, it will be referred to as a “first OS”), and operates on the first OS. The OS providing apparatus 2 stores a second operating system (hereinafter, it will be referred to as a “second OS”). This example assumes that the client terminal 1 stores only a first OS. However, the client terminal 1 may store more than one OS initially, and the OS providing apparatus 2 may store an additional OS other than the OSes stored by the client terminal 2. Further, the OS providing apparatus 2 may store more than the second OS.

If the user wants to change the first OS to the second OS to run the client terminal 1 on the second OS instead of the first OS, data used in the first OS is deleted according to the conventional art, and thus the data used in the first OS would not be reused in the second OS. According to the exemplary embodiment, files used on the first OS of the client terminal 1 are backed up in the OS providing apparatus 2 before the data used in the first OS is deleted from the client terminal 1. Then, the client terminal 1 receives the second OS and some files among the backed-up files that are executable in the second OS from the OS providing apparatus 2. Consequently, some of the files that have been executed on the first OS can be reused on the second OS.

Data exchange between the client terminal 1 and the OS providing apparatus 2 may be performed through a peripheral device of the client terminal 1, such as a modem, a wireless local access network (WLAN), radio-frequency blocks, a universal serial bus (USB), and the like, a wired/wireless communication protocol processed by processors of system memory, or Internet protocol such as TCP/IP.

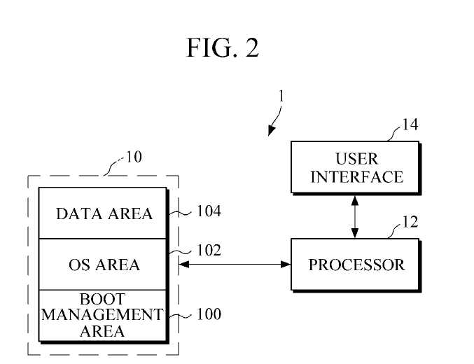

FIG. 2 is a diagram illustrating a client terminal according to an exemplary embodiment of the present invention.

Referring to FIG. 2, the client terminal 1 includes a memory 10, a processor 12, and a user interface 14.

The example of FIG. 2 schematically illustrates only primary units of the client terminal 1 for convenience of explanation. Thus, the client terminal 1 may further include other elements to perform functions for operation of the client terminal 1. The further included elements may vary according to a type or functions of the client terminal 1.

As shown in FIG. 2, the memory 10 includes a boot management area 100, an OS area 102, and a data area 104. The boot management area 100, the OS area 102, and the data area 104 may be formed in non-volatile memory such as a flash memory.

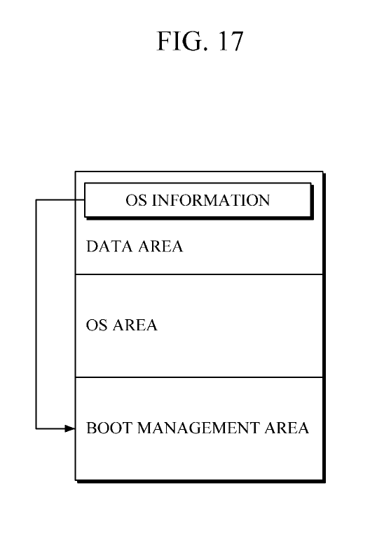

The boot management area 100 may be referred to as a boot-loader or BIOS. The boot management area 100 initializes a system of the client terminal 1, and loads and runs the OS when the client terminal 1 boots. Functions of the boot management area 100 will be described in more detail with reference to FIG. 17.

There is one OS present in the OS area 102. For example, the OS present in the OS area 102 may be Android® provided by Google, MS Windows Mobile, or iOS provided by Apple. Because the client terminal 1 lacks the operating capability compared to a personal computer, only one OS is used. For example, the client terminal 1 may require a relatively large amount of resources to run a number of OSes, unlike a personal computer.

The data area 104 stores files. The files may include execution files, such as application, for the control of the execution of programs, and multimedia files such as music, video, images, and documents. For example, the file may be an application execution file having a file extension, for example, “.EXE” in an embedded OS such as MS Window CE, Window Mobile, and the like. As another example, the file may be an application execution file having a file extension, for example, “.APK” in an embedded OS such as Android®. The file may be loaded on execute in place (XIP) memory such as RAM upon the client terminal 1 booting up. The user may generate files using the first OS installed in the OS area 102.

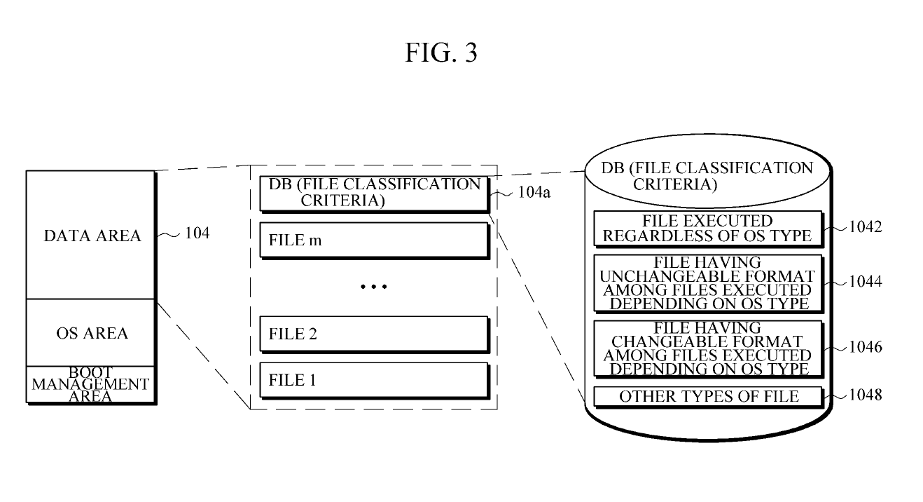

In one example, the data area 104 includes a database that stores file classification criteria that determine an OS in which a file can be executed. The file classification criteria present in the DB of the data area 104 will be described in more detail with reference to FIG. 3.

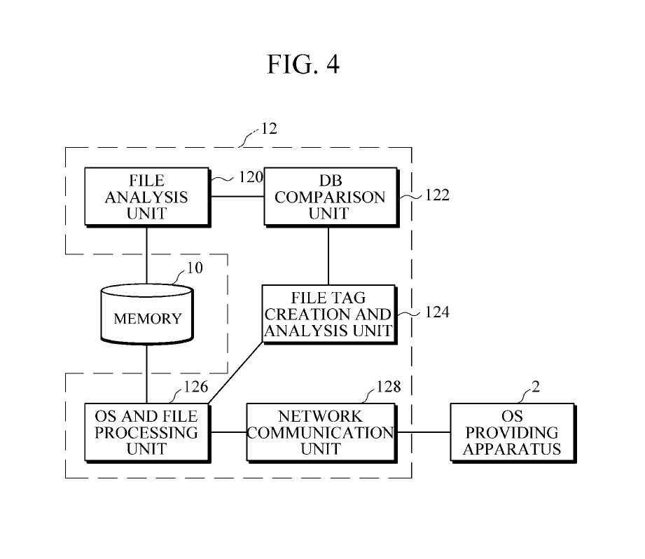

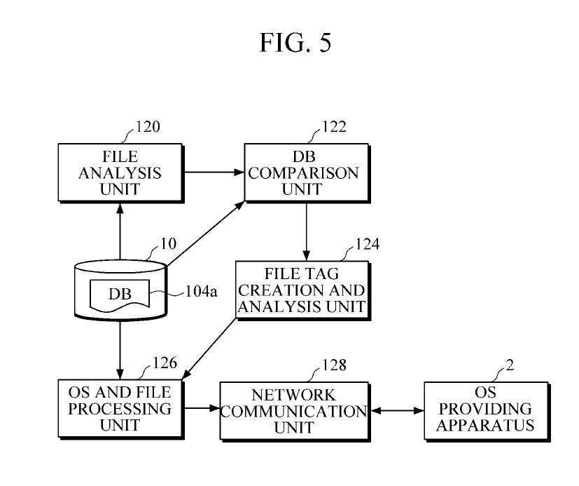

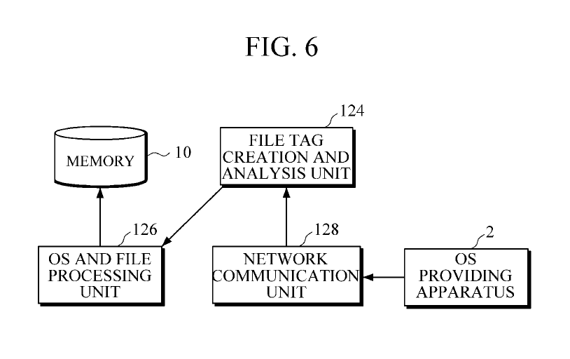

The processor 12 may perform overall management and control of operations of the client terminal 1. The processor 12 may back up the files stored in the memory 10 to the OS providing apparatus 2, and format the OS area 102 and the data area 104 of the memory 10. Then, the processor 12 may be provided with the second OS that is requested by the client terminal 1 from the OS providing apparatus 2, and may install the second OS in the OS area 102 of the memory 10. The processor 12 may be provided with a file that is executable on the second OS from the OS providing apparatus 2, and thus the provided file may be used on the second OS. The processor 12 may classify the file according to file classification criteria that are stored in the memory 10, and may back up the classified file to the OS providing apparatus 2. A configuration of the processor 12 will be described in more detail with reference to FIG. 4, FIG. 5, and FIG. 6.

The user interface 14 is an input/output device for interaction between the user and the client terminal 1. The user may input data or an instruction including a second OS installation instruction to the client terminal 1 through the user interface 14, and the client terminal 1 may output data or information to the user through the user interface 14.

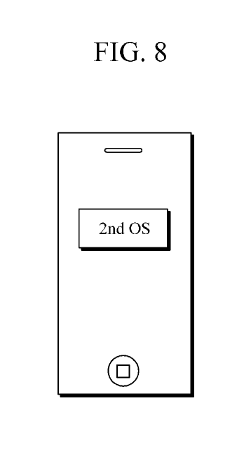

In response to a command, such as the client terminal 1 receiving the second OS installation instruction from the user through the user interface 14, the processor 12 may issue a request for personal account information to the user through the user interface so the client terminal 1 may access the OS providing apparatus 2. The access to the OS providing apparatus 2 is made by receiving the personal account information from the user. An example of the second OS installation event will be described below in more detail with reference to FIG. 8.

FIG. 3 is a diagram illustrating a configuration of a data area of a client terminal according to an exemplary embodiment of the present invention.

Referring to FIG. 3, if a user of the client terminal 1 changes the first OS to the second OS, the files that have been used on the first OS by the user are classified so as to reuse the files that can be used on the second OS. For the file classification, the file classification criteria can be stored in a database 104a of the data area 104 of the memory 10. The file classification criteria is information that enables the processor 12 to identify an OS in which a file in the client terminal 1 can be executed. The file classification criteria is information that classifies a file as a file 1042 that can be executed regardless of the type of OS, a file 1044 that is executed depending on the type of OS and has an unchangeable file format, a file 1046 that is executed depending on the type of OS and has a changeable file format, and an other file 1048 that is not classified as file 1042, file 1044, or file 1046.

The file 1042 that can be executed regardless of the type of OS can be executed on any types of OS, and may be a content file having a file extension, for example, “.avi” and “.mp4”. The file 1044 that is executed depending on the type of OS and has an unchangeable file format is a file that can be executed on a particular type of OS, for example, Apple's iOS, MS Mobile OS, or Android®. The file 1046 that is executed depending on the type of OS and has a changeable file format is a file that is executed on a particular type of OS and can be executed on a different type of OS by converting the format. That is, by converting the file 1046 into a different format using a conversion tool, the file 1046 can be executed on a particular type of OS that is different from a current OS in which the file is being executed. The other file 1048 may be a file that cannot be converted to operate on the particular type of OS. As described above, the file classification based on the dependence on the type of OS contributes to the management of the file executed on each OS.

When a file has been classified according to the file classification criteria, the file may be backed up in the OS providing apparatus 2. The first OS has been changed to the second OS in the client terminal 1, the files that can be executed on the second OS, including, for example, a file 1042 that can be executed regardless of the type of OS, a file 1044 that is executed on the second OS, and a file 1046 that cannot be currently executed on the second OS but can be executed on the second OS by converting the file by use of a conversion tool, may be provided by the OS providing apparatus 2 to the client terminal 1 and may be reused, for example, by the user. The other files 1048 may not be provided to the OS providing apparatus 2 for back-up in order to conserve network resources. Alternatively, the other files 1048 may be provided to the OS providing apparatus 2 but may not be backed up by the OS providing apparatus 2, or they may be backed up by the OS providing apparatus 2 but may not be transmitted back to the client terminal 1 for execution on the second OS.

FIG. 4 is a diagram illustrating a configuration of a processor of a client terminal according to an exemplary embodiment of the present invention.

Referring to FIG. 4, the processor 12 includes a file analysis unit 120, a database (DB) comparison unit 122, a file tag creation and analysis unit 124, an operating system and file processing unit 126, and a network communication unit 128.

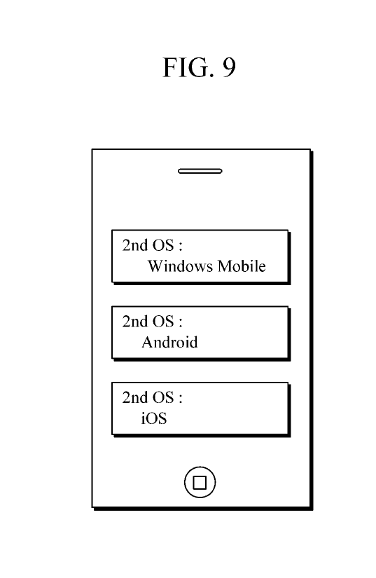

The network communication unit 128 provides a client terminal 1 with a communication function to access an OS providing apparatus 2. The network communication unit 128 may communicate with a data receiving unit and data transmitting unit (not shown) of the OS providing apparatus 2. The network communication unit 128 may collect information about a second OS to be installed in the client terminal 1 from the OS providing apparatus 2. For the collection of the second OS information, the network communication unit 128 may transmit an OS information request message to the OS providing apparatus, and enable a check of the second OS information that is present in the OS providing apparatus 2 based on a response message that is received from the OS providing apparatus 2. The second OS information collected by the network communication unit 128 may be displayed on a display through the user interface 14 (shown in FIG. 2). The display of the second OS information will be described in more detail below with reference to FIG. 9.

The processor 12 may back up the files present in the memory 10 to the OS providing apparatus 2 before installing the second OS and before formatting a data area of the memory 10. The processor 12 may classify the files stored in the memory 10 using the DB comparison unit 122 according to the file classification criteria described above with reference to FIG. 3, and thereafter, may transmit the classified files through the network communication unit 128 to the OS providing apparatus 2. Alternatively, the processor 12 may back up the files to the OS providing apparatus 2 through the network communication unit 128 without using the DB comparison unit 122 for file classification. The OS providing apparatus 2 may classify the files and then the processor 12 may receive the classified files from the OS providing apparatus 2.

The network communication unit 128 may transmit the files classified according to the file classification criteria to the OS providing apparatus 2, or receive a file that can be executed on the second OS from the OS providing apparatus 2. The files stored in the memory 10 of the client terminal 1 may each be classified as a file 1042 that can be executed regardless of the type of OS, or a file 1044 that is executed depending on the type of OS, and a file 1046 that is executed depending on the type of OS and can be executed on the second OS after file format conversion.

The network communication unit 128 may transmit the files classified according to the file classification criteria to the OS providing apparatus 2, and the OS providing apparatus 2 may classify the files according to the file classification criteria. For example, a file 1044 that can be executed regardless of the type of OS may be a content file, for example, an “.avi” file and a “.jpg” file, and the content file may be transmitted and stored in a file area of the OS providing apparatus 2 that includes files 1044 which can be executed regardless of the type of OS. As described above, as the OS providing apparatus 2 can classify the files, the client terminal 1 may download or classify the file using this classification information of the OS providing apparatus 2.

The network communication unit 128 may back up all files in the OS providing apparatus 2, and download the second OS from the OS providing apparatus 2. To download the second OS, the network communication unit 128 may transmit an OS request message to the OS providing apparatus 2, and receive the second OS from the OS providing apparatus 2.

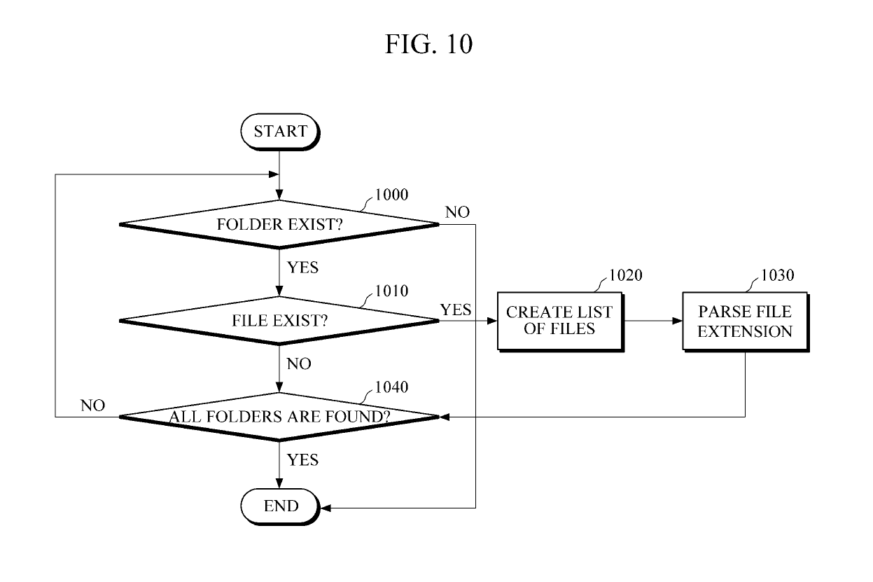

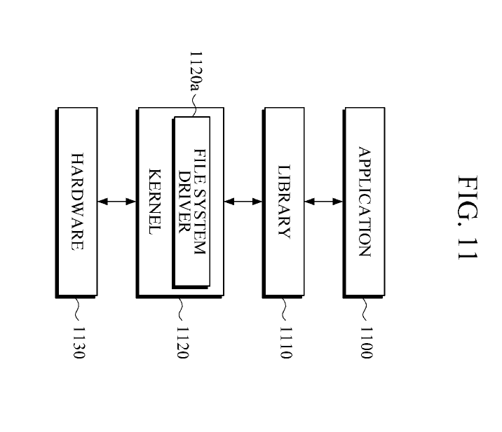

The file analysis unit 120 may search for a file in the memory 10. As a result of file search, if the file is present in the memory 10, the file analysis unit 120 may parse a file extension of the found file and identify a type of the file. The type of file may be identified by parsing the file extension, for example, by detecting ‘.’ before the file extension. The check process of the presence of the file and the file parsing operation of the file analysis unit 120 will be described in more detail below with reference to FIG. 10 and FIG. 11.

The file analysis unit 120 may transmit a DB comparison request message to the DB comparison unit 122 to check an OS in which the file found in the memory 10 is executable, and receive a response message from the DB comparison unit 122 indicating that the DB comparison unit 122 is ready and available to perform a comparison. The file analysis unit 120 may transmit the file extension of the file to the DB comparison unit 122.

If the DB is implemented by a process, the file analysis unit 120 and the DB comparison unit 122 may be connected to each other using a communication technique such as a pipe or IPC. If the DB is an area that only stores data on the memory, the connection between the file analysis unit 120 and the DB comparison unit 122 may be implemented by a memory access technique.

The DB comparison unit 122 may compare the file received from the file analysis unit 120 with the file classification criteria present in the data area DB of the memory 10, and identify whether the file is in accordance with certain file classification criterion. That is, the DB comparison unit 122 determines whether the file received from the file analysis unit 120 is a file 1042 that can be executed regardless of the type of OS, a file 1044 that is executed depending on the type of OS and has an unchangeable format, a file 1046 that is executed depending on the type of OS and has a changeable format, or other types of file 1048.

In response to the DB comparison unit 122 determining the type of the file analyzed by the file analysis unit 120, the file tag creation and analysis unit 124 creates a file tag that identifies the type of file. The created file tag may be transmitted along with the file to the OS providing apparatus 2 through the network communication unit 128.

In response to the file tag being received from the OS providing apparatus 2, the file tag creation and analysis unit 124 may analyze the file tag and identify the type of the received file according to the file classification criteria.

The OS and file processing unit 126 may delete the OS area and data area of a non-volatile memory in the client terminal 1 so as to install the second OS. In response to the second OS being received from the OS providing apparatus 2 through the network communication unit 128, the OS and file processing unit 126 may load the downloaded second OS into a volatile memory of the client terminal 1, and install the second OS in the non-volatile memory.

In response to a file being downloaded from the OS providing apparatus 2 through the network communication unit 128, the OS and file processing unit 126 may classify the received file according to the tag analysis result from the file tag creation and analysis unit 124, and store the classified file in the data area of the memory 10. As described above, if the client terminal 1 reboots up after the OS and file processing unit 126 has downloaded the OS and file, the client terminal 1 is changed to a system that runs on the second OS.

FIG. 5 is a diagram illustrating a configuration of a processor of a client terminal according to an exemplary embodiment of the present invention.

Referring to FIG. 5, in the occurrence of a second OS installation event, a network communication unit 128 of the client terminal 1 accesses the OS providing apparatus 1 and collects information about the second OS to be installed in the client terminal 1 from the OS providing apparatus 2. In this example, the client terminal 1 may display the collected second OS information on a display through the user interface 14.

Thereafter, a file analysis unit 120 may analyze a file stored in the memory, and a DB comparison unit 122 may compare the analyzed file with file classification criteria that is stored in a DB 104a of a memory 10. The file comparison unit 120 may classify the file into a file 1042 that can be executed regardless of the type of OS, a file 1044 that is executed depending on the type of OS and has an unchangeable format, a file 1046 that is executed depending on the type of OS and has a changeable format, or other types of file 1048.

Then, a file tag creation and analysis unit 124 may create a file tag that identifies an OS in which each file classified by the file comparison unit 120 can be executed. The file tag may be transmitted to an OS and file processing unit 126.

The OS and file processing unit 126 may receive the file tag from the file tag creation and analysis unit 124 and receive a file from the memory 10, and transmit the received file tag and file to the OS providing apparatus 2 through a network communication unit 128 for backup. At this time, the network communication unit 128 may use an Internet protocol such as TCP/IP to transmit the file and file tag to the OS providing apparatus 2.

FIG. 6 is a diagram illustrating a configuration of a processor of a client terminal according to an exemplary embodiment of the present invention.

The client terminal 1 may receive from the OS providing apparatus 2 a second OS and a file that can be executed on the second OS through a network communication unit 128. The file that can be executed on the second OS may be a file 1042 that can be executed regardless of the type of OS, a file 1044 that is executed on the second OS, and a file 1046 that cannot be currently executed on the second OS but can be executed on the second OS by converting the file by use of a conversion tool.

In response to the file and the file tag being received from the OS providing apparatus 2, a file tag creation and analysis unit 124 may verify an OS in which the received file can be executed. Thereafter, an OS and file processing unit 126 may store file data except the OS or tag information in the memory 10.

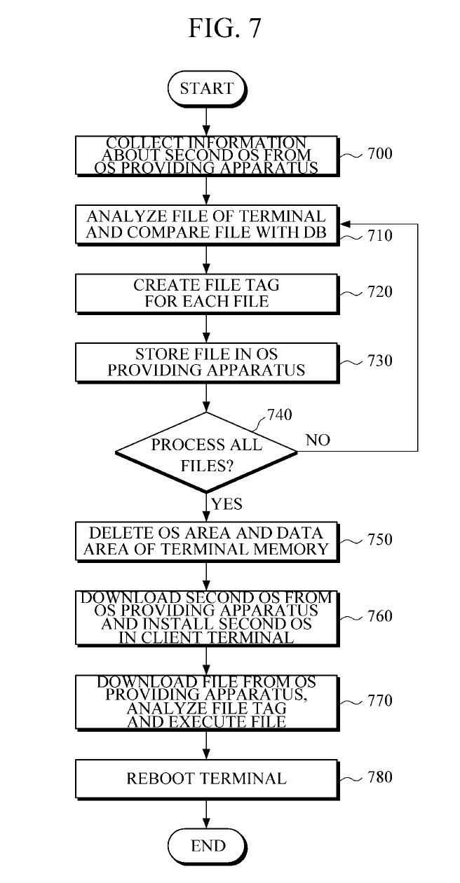

FIG. 7 is a flowchart illustrating a method for supporting multiple OSes according to an exemplary embodiment of the present invention. FIG. 7 will be described as if performed by the client terminal 1 and OS providing apparatus 2 shown in FIG. 1 and FIG. 2, but is not limited as such.

Referring to FIG. 7, in response to the occurrence of a second OS installation event such as a user requesting a transition from a first OS to a second OS, the client terminal 1 accesses the OS providing apparatus 2 and collects information about a second OS to be installed in the client terminal 1 from the OS providing apparatus 2 (700).

Then, the client terminal 1 analyzes a file stored in the memory 10 and compares the analyzed file with file classification criteria stored in a DB of the memory 10 (710). At this operation, through the comparison, the client terminal 1 may classify the file into a file 1042 that can be executed regardless of the type of OS, a file 1044 that is executed depending on the type of OS and has an unchangeable format, a file 1046 that is executed depending on the type of OS and has a changeable format, or other types of file 1048.

Then, the client terminal 1 creates a file tag that identifies the OS in which each of the classified files can be executed (720). The client terminal 1 transmits the file and the created file tag to the OS providing apparatus 2 and then the OS providing apparatus 2 stores the received file and file tag (730). The operations 710 through 730 are repeatedly performed until all files stored in the data area of memory 10 are transmitted to the OS providing apparatus 2 (740). Alternatively, although not shown, only files 1042, files 1044, and files 1046 may be transmitted to OS providing apparatus 2, and files 1048 may not be transmitted to OS providing apparatus 2 and stored.

Thereafter, the client terminal 1 formats the data area and the OS area of the memory to install the second OS (750). The client terminal 1 installs the second OS received from the OS providing apparatus 2 in the formatted OS area (760), and afterwards receives a file that can be executed on the second OS and an associated file tag from the OS providing apparatus 2 (770). At this operation, the OS may verify that the file can be executed on the second OS. The client terminal 1 is then changed to a system that runs on the second OS upon rebooting (780).

FIG. 8 is a diagram illustrating a display of a client terminal on which a second OS installation event is displayed according to an exemplary embodiment of the present invention. FIG. 8 will be described as if performed by the client terminal 1 and OS providing apparatus 2 shown in FIG. 1 and FIG. 2, but is not limited as such.

Referring to FIG. 8, the client terminal 1 may provide a user with a graphic user interface (GUI) for initiating the second OS installation event through the user interface 14. The second OS installation event may be a user requesting a transition from a first OS to a second OS via the user interface 14. In response to a second OS installation event execution instruction being received from the user, the client terminal 1 may issue a request for personal account information to the user so as to access the OS providing apparatus 2. In this example, the access to the OS providing apparatus 2 can be made using the personal account information provided by the user.

FIG. 9 is a diagram illustrating a display of a client terminal according to an exemplary embodiment of the present invention. FIG. 9 will be described as if performed by the client terminal 1 and OS providing apparatus 2 shown in FIG. 1 and FIG. 2, but is not limited as such.

Referring back to FIG. 2, the client terminal 1 collects the second OS information about a second OS to be installed in the client terminal 1 from the OS providing apparatus 2. To initiate this receipt of second OS information, the client terminal 1 transmits an OS information request message to the OS providing apparatus 2 through the network communication unit 128 (referring back to FIG. 4, FIG. 5, or FIG. 6). By receiving a response message from the OS providing apparatus 2, the client terminal 1 enables a check of the second OS information that is present in the OS providing apparatus 2 based on the response message. The second OS information may be displayed on the display of the client terminal 1 through the user interface 14. For example, as shown in FIG. 9, MS Windows Mobile, Android®, iOS, and the like that are stored in the OS providing apparatus 2 may be displayed. Thus, the second OS installation event described above with respect to FIG. 8 may be a user selecting one among two or more possible second OSes displayed on a display.

FIG. 10 is a flowchart illustrating a method for performing a file searching operation and a file parsing operation according to an exemplary embodiment of the present invention. FIG. 10 will be described as if performed by the file analysis unit 120 of one of FIG. 4, FIG. 5, and FIG. 6, but is not limited as such.

Referring to FIG. 10, the folder is searched for in the memory (1000), and if a folder exists in the memory 10, it is detected whether a file is present in the folder (1010). If a file is present in the folder as a result of step 1010, the file analysis unit 120 creates a list of files in the folder (1020), and identifies the type of the file by parsing a file extension of the file (1030). The file extension parsing may be performed by detecting, for example, ‘.’ before the file extension and identifying the file extension. The operations 1000 through 1030 are repeatedly performed until all folders and all files in each folder are found (1040).

FIG. 11 is a diagram illustrating a configuration of software and hardware for a client terminal according to an exemplary embodiment of the present invention. FIG. 11 will be described as if performed by the client terminal 1 and OS providing apparatus 2 shown in FIG. 1 and FIG. 2, but is not limited as such.

Referring to FIG. 11, an application 1100 side of the client terminal 1 may search for a file using an application programming interface (API) function. The API function is supported in an API library 1110. The API function may be, for example, FindFirstFile, FindNextFil, and the like. The application 1100 may interwork with a file system driver 1120a in a kernel 1120 side using the API function, and read a file extension of a file present in a memory in a hardware 1130 side. The memory in the hardware 1130 side may store the file in a directory, define a file name and a file extension, and set up a path to the file by use of a directory structure. The application 1100 may search for the file path of the file that is stored in the memory in the hardware 1130 side, and read the file extension of the file for which the file path has been found. For example, ‘.’ that is positioned before the file extension may be detected by reading the file name from the first character, and the file extension following ‘.’ may be identified.

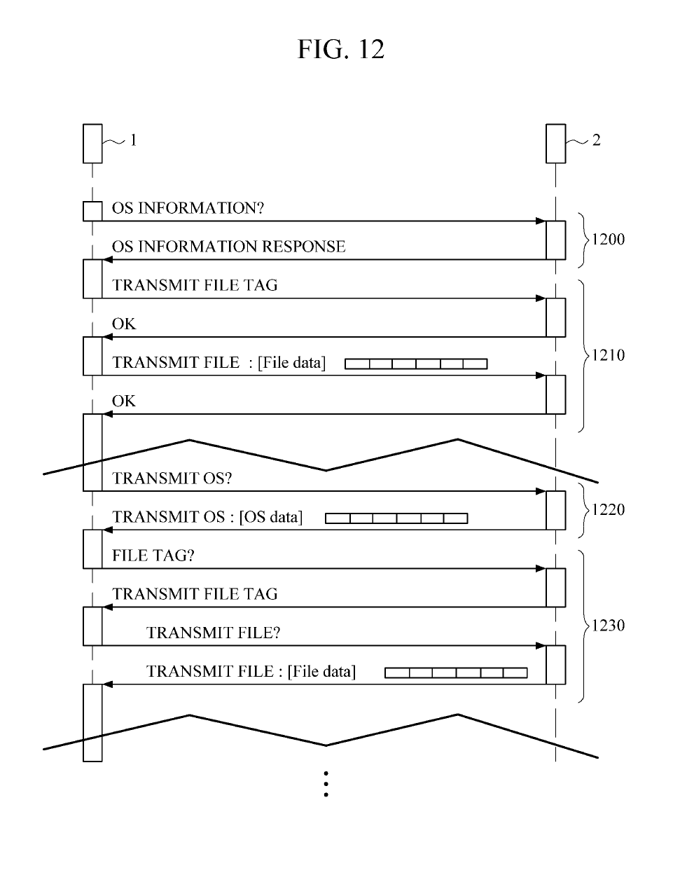

FIG. 12 is a flowchart illustrating a method for performing a communication process between a client terminal and an OS providing apparatus according to an exemplary embodiment of the present invention. FIG. 12 will be described as if performed by the client terminal 1 and OS providing apparatus 2 shown in FIG. 1 and FIG. 2, but is not limited as such.

Referring to FIG. 12, with the occurrence of a second OS installation event, the client terminal 1 accesses the OS providing apparatus 2 and transmits a second OS information request message to the OS providing apparatus 2, and collects information about the second OS to be installed on the client terminal 1 from the OS providing apparatus 2 (1200). For example, the second OS information may indicate Android® provided by Google.

The client terminal 1 classifies a file that is stored in the memory 10 according to file classification criteria that is present in a DB of the memory 10, creates a file tag that identifies the OS in which each classified file can be executed, and transmits the file and the associated file tag to the OS providing apparatus 2 (1210).

Thereafter, the client terminal 1 formats a data area and an OS area of the memory 10 so as to install the second OS, and installs the second OS that has been transmitted from the OS providing apparatus 2 (1220). Thereafter, the client terminal 1 receives the files (files 1042, 1044, and 1046) that can be executed on the second OS and the relevant file tags from the OS providing apparatus 2 and stores the received files in the memory 10 (1230). Alternatively, the client terminal 1 may receive all files and all file tags that have been transmitted to the OS providing apparatus 2 from the client terminal 1 for backup, and the client terminal 1 may store only files (files 1042, 1044, and 1046) in the memory 10 that can be executed on the second OS and delete the rest of the received files (files 1048). Each file may be further verified to confirm an OS in which the file can be executed. For example, it may be identified based on a file tag whether the file is executed on Android®. The client terminal 1 is then changed to a system that runs on the second OS upon rebooting.

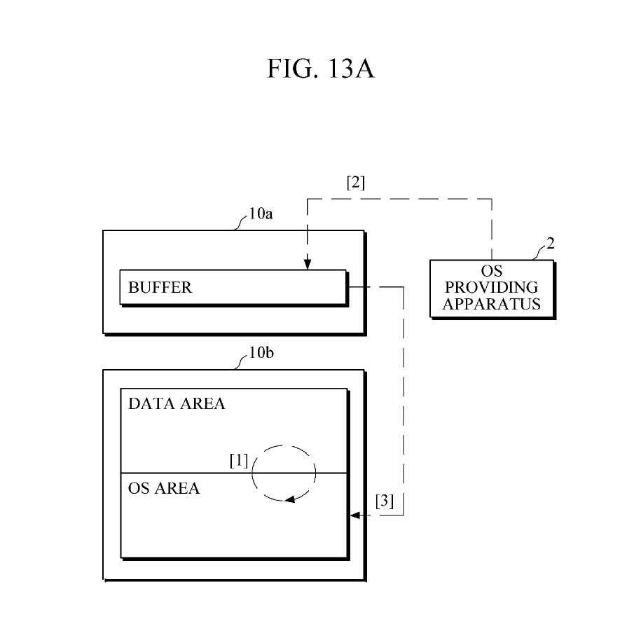

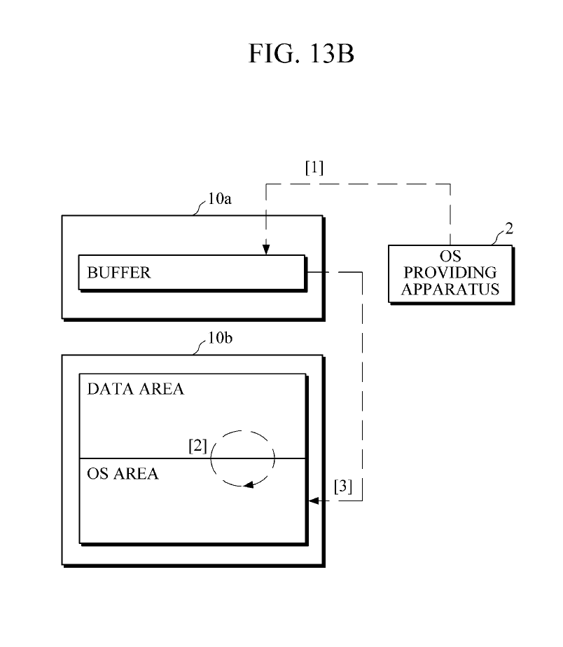

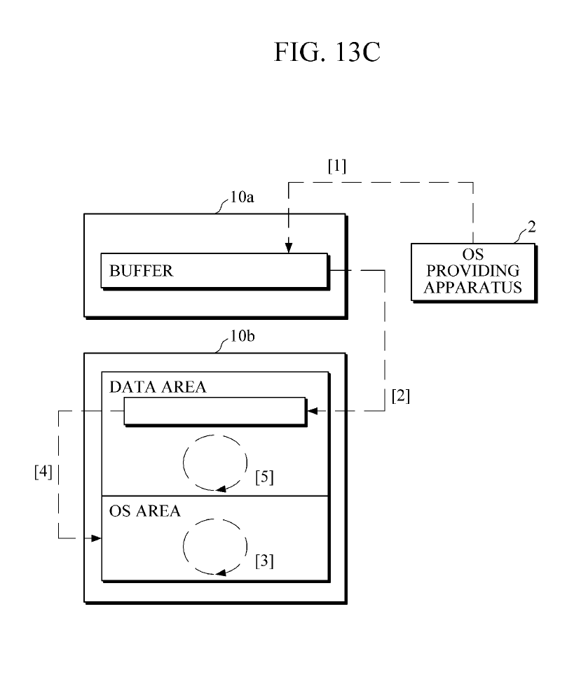

FIG. 13A, FIG. 13B, and FIG. 13C are diagrams illustrating a process of a client terminal installing a second OS downloaded from an OS providing apparatus according to an exemplary embodiment of the present invention. FIG. 13A, FIG. 13B, and FIG. 13C will be described as if performed by the client terminal 1 and OS providing apparatus 2 shown in FIG. 1 and FIG. 2, but are not limited as such.

In the examples shown in FIG. 13A, FIG. 13B, and FIG. 13C, a memory 10 of the client terminal 1 may include a non-volatile memory 10b such as Flash memory, and a volatile memory 10a such as RAM.

Referring to FIG. 13A, the client terminal 1 formats a data area and an OS area of the non-volatile memory 10b so as to install the second OS that will be downloaded from the OS providing apparatus 2 [1]. Thereafter, the client terminal 1 downloads the second OS from the OS providing apparatus 2, and stores it to a buffer of the volatile memory 10a [2]. Then, the client terminal 1 installs the second OS that is copied in the buffer of the volatile memory 10a into the formatted OS area of the non-volatile memory 10b [3].

Referring to FIG. 13B, the client terminal 1 first downloads the second OS from the OS providing apparatus 2 and stores the second OS in the buffer of the volatile memory 10a [1]. Thereafter, the client terminal 1 formats the data area and the OS area of the non-volatile memory 10b [2], and then installs the second OS copied in the buffer of the volatile memory 10a into the formatted OS area of the non-volatile memory 10b [3].

Referring to FIG. 13C, the client terminal 1 downloads the second OS from the OS providing apparatus 2 and stores it to the buffer of the volatile memory 10a [1]. Thereafter, the client terminal 1 stores the second OS that is copied in the buffer of the volatile memory 10a to a predefined area within the data area of the non-volatile memory 10b [2]. Then, the client terminal 1 formats the OS area of the non-volatile memory 10b [3], and installs the second OS that is stored in the predefined area within the data area of the non-volatile memory 10b in the formatted OS area of the non-volatile memory 10b [4]. Then, the client terminal 1 formats the data area of the non-volatile memory 10b [5].

The above processes for downloading and installing the second OS shown in FIG. 13A, FIG. 13B, and FIG. 13C are only for purposes of example, and the second OS download and installation may be performed in other ways.

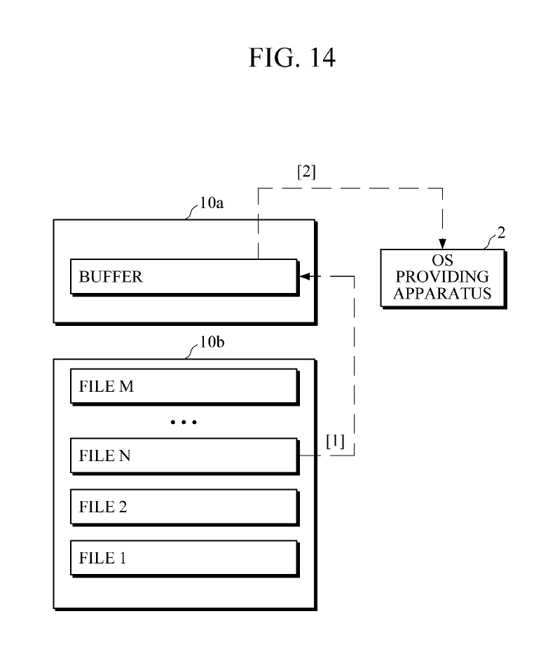

FIG. 14 is a diagram illustrating a method of a client terminal backing up a file in an OS providing apparatus according to an exemplary embodiment of the present invention. FIG. 14 will be described as if performed by the client terminal 1 and OS providing apparatus 2 shown in FIG. 1 and FIG. 2, but is not limited as such.

In the example shown in FIG. 14, a memory 10 of the client terminal 1 may include a non-volatile memory 10b such as Flash memory and a volatile memory 10a such as RAM. The client terminal 1 copies a file stored in the data area of the non-volatile memory 10b to the buffer of the volatile memory 10a so as to back up the file [1]. Then, the client terminal 1 transmits the file copied in the buffer of the volatile memory 10a to the OS providing apparatus 2 [2].

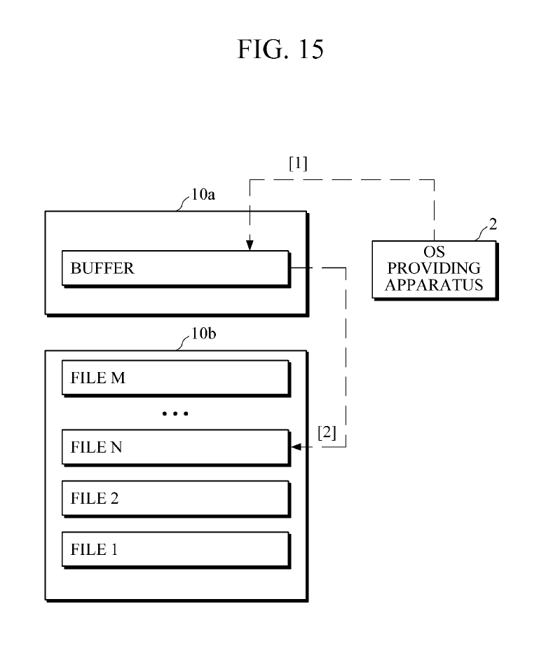

FIG. 15 is a diagram illustrating a method of a client terminal fetching a file backed up in an OS providing apparatus and restoring the file in the client terminal according to an exemplary embodiment of the present invention. FIG. 15 will be described as if performed by the client terminal 1 and OS providing apparatus 2 shown in FIG. 1 and FIG. 2, but is not limited as such.

In the example shown in FIG. 15, a memory 10 of the client terminal 1 may include a non-volatile memory 10b such as Flash memory and a volatile memory 10a such as RAM. The client terminal 1 receives a file from the OS providing apparatus 2 and copies the file to a buffer of the volatile memory 10a so as to restore the file [1]. Then, the client terminal 1 stores the copied file in a data area of the non-volatile memory 10b [2].

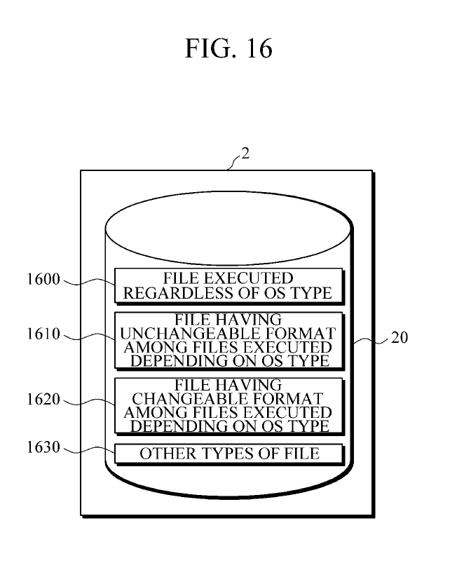

FIG. 16 is a diagram illustrating a storage area of an OS providing apparatus according to an exemplary embodiment of the present invention.

The OS providing apparatus 2 receives a file from a client terminal 1 and stores it, and provides the stored file back to the client terminal 1 on request.

The OS providing apparatus 2 may receive a file tag along with the file from the client terminal 1 to identify the OS in which the received file can be executed, and may classify the received file based on the file tag and store the file in the storage area 20 in accordance with the file classification criteria. For example, as shown in FIG. 16, the file may be classified as a file 1600 that can be executed regardless of the type of OS, a file 1610 that is executable depending on the type of OS and has an unchangeable file format, a file 1620 that is executable depending on the type of OS and has a changeable file format, or an other type of file 1630. The classified file may be stored in a corresponding region in the storage area 20.

Alternatively, the OS providing apparatus 2 may store file classification criteria that determine the OS in which a file can be executed. Thus, in response to receiving a file from the client terminal 1, the OS providing apparatus 2 classifies the received file according to the file classification criteria, and the classified file may be stored in a corresponding region in the storage area 20.

The file transmission between the client terminal 1 and the OS providing apparatus 2 may be performed by using Internet protocol, for example, file transfer protocol (FTP). The storage area 20 of the OS providing apparatus 2 may include a conversion tool that converts a format of a file that cannot be executed on the second OS until converting its format. The conversion tool may be provided in the client terminal 1.

The storage area 20 of the OS providing apparatus 2 may be extended to, for example, an SD card, or another memory that is separate from the main system memory of the client terminal 1. The SD card is a non-volatile memory card format to be used in the portable client terminal 1.

FIG. 17 is a diagram illustrating a memory in a client terminal according to an exemplary embodiment of the present invention.

A function of the boot management area may vary with the type of OS. The boot management area may be operated in the same manner as a method for operating multiple operating systems. A data area stores OS information, and a boot management area sets system settings in conformity with the OS information and boots the client terminal 1. The OS information may be stored and managed in a part of the data area which is not reformatted, and thus the boot management area can use the OS information from the data area to boot a system of the client terminal 1 to operate according to the second OS.

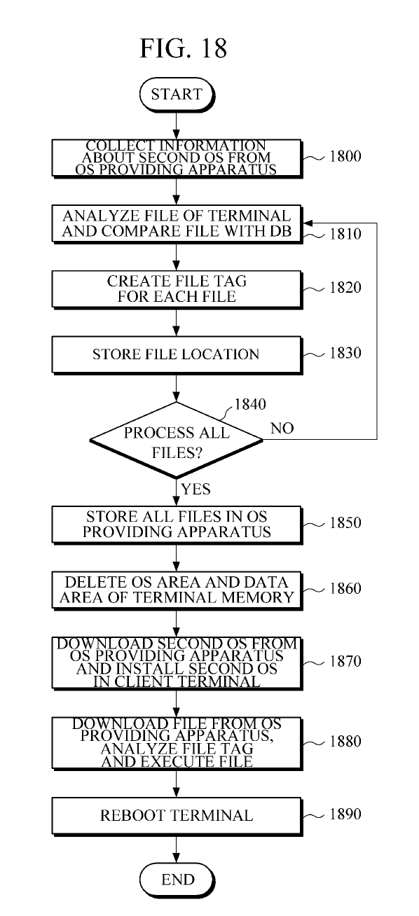

FIG. 18 is a flowchart illustrating a method for supporting multiple OSes according to an exemplary embodiment of the present invention.

Referring back to the method shown in and described with respect to FIG. 7, the client terminal 1 transmits each file separately to the OS providing apparatus 2 (this method of transmission will be referred to as the client terminal 1 transmitting each file “directly” to the OS providing apparatus 2, although such direct transmission could include a transmission from the client terminal 1 to an intermediate receiver, such as a network node, before being received by the OS providing apparatus 2). To the contrary, as shown in the method of FIG. 18, the client terminal 1 transmits all files at once to the OS providing apparatus 2 after confirming the locations of each file.

Hereinafter, the description of the method for supporting multiple OSes will be provided, focusing on the aforementioned difference between FIG. 7 and FIG. 18. FIG. 18 will be described as if performed by the client terminal 1 and OS providing apparatus 2 shown in FIG. 1 and FIG. 2, but is not limited as such.

Referring to FIG. 18, in the occurrence of a second OS installation event, the client terminal 1 accesses the OS providing apparatus 2 and collects information about a second OS to be installed in the client terminal 2 (1800).

Then, the client terminal 1 analyzes a file that is stored in the memory 10 of the client terminal 1 and compares the analyzed file with file classification criteria stored in a DB of the memory 10 (1810). At this operation, through the comparison, the client terminal 1 may classify the file into a file 1042 that can be executed regardless of the type of OS, a file 1044 that is executed depending on the type of OS and has an unchangeable format, a file 1046 that is executed depending on the type of OS and has a changeable format, or an other types of file 1048.

Then, the client terminal 1 creates a file tag for each of the classified files, which identifies the OS in which the file can be executed (1820). Then, the client terminal 1 recognizes locations of each file (1830), and once all files have been processed (1840) transmits all files together to the OS providing apparatus 2 (1850).

The client terminal 1 formats a data area and an OS area of the memory 10 (1860). Then, the client terminal 1 is provided with the second OS from the OS providing apparatus 2, and installs the second OS in the formatted OS area (1870). Then, the client terminal 1 receives a file that can be executed on the second OS and a relevant file tag (1880). At this operation, the file may be stored in the memory 10 after the OS in which the file can be executed is verified. Then, the client terminal 1 is changed to a system that runs on the second OS upon rebooting (1890).

According to the exemplary embodiments as described above, when a user changes a first OS to a second OS for running a client terminal that may not be able to support multiple OSes due to restricted hardware resources, files that can be executed on the second OS from among files that are executed on the first OS can be reused according to a file classification criteria and a backup of the files to an OS providing apparatus. The above described embodiments may be applied to a client terminal that does not support virtualization or a general client terminal that supports only a single OS.

While the exemplary embodiments have been shown and described, it will be understood by those skilled in the art that various changes in form and details may be made thereto without departing from the spirit and scope of the present invention as defined by the appended claims and their equivalents. In addition, many modifications can be made to adapt a particular situation or material to the teachings of the present disclosure without departing from the essential scope thereof. Therefore, it is intended that the present invention include the modifications and variations of the invention provided they come within the scope of the appended claims and their equivalents.

What is claimed is:

1. A terminal configured to run a first operation system (OS), comprising:
a memory comprising a data area and an OS area; and
a processor configured to back up a file stored in the data area to an OS providing apparatus, to format the OS area, to install a second OS received from the OS providing apparatus, and to restore the file to the data area.

2. The terminal of claim 1, wherein the terminal receives information about the second OS, and the processor comprises a comparison unit configured to determine whether the file is a type of file that is executable on the second OS.

3. The terminal of claim 2, wherein the processor further comprises a file tag creation and analysis unit configured to create a file tag identifying the type of the file.

4. The terminal of claim 1, wherein the processor comprises a network communication unit to transmit the file to the OS providing apparatus, to receive the second OS from the OS providing apparatus, and to receive the file from the OS providing apparatus for restoring the file to the data area.

5. The terminal of claim 1, wherein if the data area comprises a file that is not executable on the second OS, the processor formats the data area without backing up the file that is not executable on the second OS.

6. An operating system (OS) providing apparatus, comprising:
a data receiving unit to receive data via a communication network;
a memory to store a first operation system (OS); and
a data transmitting unit to transmit data via the communication network, and to transmit the first OS to a terminal running a second OS.

7. The OS providing apparatus of claim 6, wherein if the data receiving unit receives a request for the first OS from the terminal, the data transmitting unit transmits OS information identifying the first OS to the terminal.

8. The OS providing apparatus of claim 6, wherein the data receiving unit receives a file and a file tag corresponding to the file from the terminal, the file tag identifying whether the file is a type of file that is executable on the first OS.

9. The OS providing apparatus of claim 8, wherein if the file tag identifies the file as a type of file that is executable on the first OS, the OS providing apparatus backs up the file to a memory and the data transmitting unit retransmits the file and the file tag to the terminal.

10. The OS providing apparatus of claim 8, wherein the file tag identifies the type of file according to an extension of the file name.

11. The OS providing apparatus of claim 6, wherein the data receiving unit receives a file and a file tag corresponding to the file from the terminal, classifies the file according to whether the file is a type of file that is executable on the first OS, and stores the file according to file classification criteria.

12. A method for managing multiple operating systems (OSes) at a terminal, comprising:
running a first OS;
collecting information about a second OS from an OS providing apparatus;
backing up a first file stored in a data area of a memory to the OS providing apparatus;
formatting an OS area of the memory;
receiving the second OS from the OS providing apparatus and installing the second OS to the OS area;
restoring the first file to the data area; and
running the second OS.

13. The method of claim 12, further comprising formatting the data area without backing up a second file that is not executable on the second OS.

14. The method of claim 12, further comprising:
collecting information about a third OS from the OS providing apparatus; and
displaying the second OS information and the third OS information on a display of the terminal.

15. The method of claim 12, further comprising determining whether the first file stored in the data area of the memory is executable on the second OS.

16. The method of claim 15, wherein determining whether the first file stored in the data area of the memory is executable on the second OS further comprises:
determining whether the first file is a file type that is executable on a plurality of types of OS;
determining whether the first file is a file type that is executable based on a type of OS and has a file format that is unchangeable; and
determining whether the first file is a file type that is executable on the second OS only if a file format is converted.

17. The method of claim 15, wherein all files that are stored in the data area and are executable on the second OS are backed up to the OS providing apparatus and restored to the data area.

18. A method for managing multiple operating systems (OSes) at an OS providing apparatus, comprising:
receiving a request from a terminal running a first OS;
transmitting information about a second OS to the terminal in response to the request;
receiving a first file from the terminal;
storing the first file in a memory;
transmitting the second OS to the terminal; and
transmitting the first file to the terminal.

19. The method of claim 18, further comprising determining whether the first file is executable on the second OS.

20. The method of claim 19, wherein transmitting the first file to the terminal further comprises transmitting a file tag to the terminal, the file tag identifying whether the first file is executable on the second OS.
